(19) United States
(12) Patent Application Publication
(10) Pub. No.: US 2014/0270417 A1
(43) Pub. Date: Sep. 18, 2014

(54) PORTABLE FINGERPRINT DEVICE WITH ENHANCED SECURITY

(71) Applicant: SUNASIC TECHNOLOGIES, INC., New Taipei City (TW)

(72) Inventor: Chi-Chou LIN, New Taipei City (TW)

(73) Assignee: SUNASIC TECHNOLOGIES, INC., New Taipei City (TW)

(21) Appl. No.: 13/845,223

(22) Filed: Mar. 18, 2013

(51) Int. Cl. G06K 9/00

(52) U.S. Cl. CPC G06K 9/00013
USPC 382/124

(57) ABSTRACT

A portable fingerprint device is disclosed. The device includes an image sensing unit for capturing fingerprint images of a finger; a microprocessor, linked to the image sensing unit, for recording the fingerprint images of the finger, identifying the fingerprint images of the finger from a fingerprint database, receiving a command signal and transmitting a response signal; and a communication unit, connected to the microprocessor, for exchanging the command signal and the response signal between the microprocessor and a command device separated from the portable fingerprint device. The portable fingerprint device not only can identify fingerprints, but also can detect a sequence of finger motion, or “signature”, and use such information as part of the identification/authentication process.

### FIELD OF THE INVENTION

The present invention relates to a portable fingerprint device. More particularly, the present invention relates to a portable fingerprint device with enhanced security which can detect a sequence of finger motion, or “signature”, and use such information as part of the authentication process.

### BACKGROUND OF THE INVENTION

A password is a simple tool to control computer access, internet surfing and online transactions. However, it is possible to be stolen by Trojan horse programs or guessed by someone with ill intention. In addition, if a user has many passwords for different purposes, it can be hard for him/her to memorize all of them. This is a well known password management problem. Therefore, a simple and unique tool, fingerprint, can be used in stead. There are almost no identical fingerprints of two individuals. Using fingerprint is like a unique key to open a door which is conventionally locked by password, but no need to memorize it.

Recently there are many inexpensive fingerprint readers (or modules) introduced and the market is growing fast. For example, an optical fingerprint scanner utilizes a CCD or CIS optical image sensor to digitize fingerprint image of fingertip. The Other types include semiconductor based fingerprint sensors, which may use tiny capacitors to sense the ridge and groove pattern on the fingertip. Both type of devices mentioned above, under software control, capture the ridge and groove patterns of a finger. The fingerprint image is further processed by algorithms to produce a set of feature points, which are matched against stored records to identify the valid user.

As technology advances, the fingerprint reader can be miniaturized and modulized to be embedded in some portable devices and used to protect privacy and enforce security. A USB mass storage device is a good example. Please refer to FIG. 1. U.S. Pat. No. 7,181,053, which discloses a USB mass storage device which mainly includes a housing having a predetermined size, in which an optical fingerprint identification system is mounted for use with the USB drive. A printed circuit board (PCB) is located on an inner bottom of the housing with a universal serial bus (USB) plug projected from a front end of the housing. The optical fingerprint identification system includes an image sensing element and an optical prism located across front and rear ends, respectively, of the PCB, so that a space above the PCB provides an optical path for the optical fingerprint identification system. The housing is provided at a rear end with a pivotally connected rear cover to enable easy protection of and access to a fingerprint surface on the optical prism.

Please refer to FIG. 2. It shows a commonly seen notebook computer with a fingerprint reader 1. The fingerprint reader 1 is modulized and embedded in the notebook computer so that it can be used to prevent notebook computer from unauthorized access. Only the user having fingerprint registered in the notebook computer operation system is allowed to log-in to operate the notebook computer.

Although the above inventions have been modified in different forms and applied widely in many applications, with the convenience of use, some problems follow. The most important of all is fingerprint copy. As the development of new technology, it is not difficult to get fingerprint image copied and then transfer it to a plastic material through a molding process. For instance, a finger can be coated with a layer of fine powder or oil. Then the fingerprint image can be transferred to a tape which is further used to produce a mold. Similar methods can be found on internet. Thus, devices using fingerprint security are not perfectly safe anymore. Therefore, a fingerprint device with enhanced security to solve the problem mentioned above is desperately desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a portable fingerprint device includes an image sensing unit for capturing fingerprint images of a finger; a microprocessor, linked to the image sensing unit, for recording multiple fingerprint images of the finger, identifying the fingerprint images of the finger from a fingerprint database, analyzing the sequence of fingerprint images to determine the X/Y position of the finger in each image to derive a signature pattern, comparing the signature pattern with records stored in a signature database, receiving a command signal and transmitting a response signal; and a communication unit, connected to the microprocessor, for transmitting the command signal and the response signal between the microprocessor and a command device separated from the portable fingerprint device.

Preferably, the portable fingerprint device further includes a memory unit, linked to or embedded within the microprocessor, for storing the fingerprint and signature databases.

Preferably, the portable fingerprint device includes a software.

Preferably, the microprocessor identifies the fingerprint images of the finger and signature by executing the software.

Preferably, the software instructs the microprocessor to process the fingerprint images to produce a set of feature points, compare the feature points with a set of records stored in the memory unit, analyze the sequence of fingerprint images to determine the X/Y position of the finger in each image to derive a signature pattern, comparing the signature pattern with records stored in the memory unit.

Preferably, the fingerprint images of the finger are captured at a speed of minimum 15 frames per second.

Preferably, the portable fingerprint device is a notebook computer, a USB storage device, a mobile phone or a remote control unit.

Preferably, the communication unit is a USB port or a wireless transmitting module such as a 2.4 Ghz or Bluetooth device.

Preferably, the response signal is a response of the command signal.

Preferably, the response signal includes a message that indicates whether the fingerprint images match a corresponding record in the fingerprint database or not.

Preferably, the response signal includes a message that indicates whether the signature pattern matches a corresponding record in the signature database or not

### BRIEF DESCRIPTION OF THE DRAWINGS

FIG. 1 is a prior art of a USB mass storage device with a fingerprint reader.

FIG. 2 is a prior art of a notebook with a fingerprint reader.

FIG. 3 illustrates a schematic diagram of an embodiment of the present invention.

FIG. 4 illustrates a perspective view of the embodiment of the present invention.

FIG. 5 shows how the embodiment of the present invention functions.

### DETAILED DESCRIPTION OF THE PREFERRED EMBODIMENT

The present invention will now be described more specifically with reference to the following embodiment.

Please refer to FIG. 3 to FIG. 5. An embodiment of the present invention is disclosed. FIG. 3 illustrates a schematic diagram of an embodiment of the present invention, FIG. 4 illustrates a perspective view of the embodiment of the present invention and FIG. 5 shows how the embodiment of the present invention functions.

A portable fingerprint device 10 includes an image sensing unit 101, a microprocessor 102, a communication unit 103, a memory unit 104 and a housing 105. The image sensing unit 101 is used for capturing fingerprint images of a finger. In this embodiment, the image sensing unit 101 is a capacitor type fingerprint reader. The microprocessor 102 is linked to the image sensing unit 101. The microprocessor 102 can record the fingerprint images of the finger, identify the fingerprint images of the finger from a fingerprint database, analyze the sequence of fingerprint images to determine the X/Y position of the finger in each image to derive a signature pattern, compare the signature pattern with records stored in a signature database, receive a command signal and transmit a response signal.

The communication unit 103 is connected to the microprocessor 102 and can transmit the command signal and the response signal between the microprocessor 102 and a command device 20. The command device 20 is separated from the portable fingerprint device 10. The connection is presented by a dashed line in FIG. 3. The memory unit 104 is linked to or embedded within the microprocessor 102. The memory unit stores the fingerprint and the signature databases. The housing 105 is used to enclose and protect the image sensing unit 101, the microprocessor 102, the communication unit 103 and the memory unit 104. It should be emphasized that the housing 105 is not necessary according to the spirit of the present invention. The portable fingerprint device 10 can be modulized for another device or equipment so that it is not important if the portable fingerprint device 10 has a protection mechanism or not. Please refer to FIG. 4. According to the embodiment of the present invention, the portable fingerprint device 10 is a USB storage device. The portable fingerprint device 10 uses a USB connector to transmit data and connect with the command device 20.

When a user initiates the portable fingerprint device 10 by scanning his fingerprint by the image sensing unit 101, the fingerprint image data is sent to the microprocessor 102. The microprocessor 102 will identify the fingerprint images of the finger and signature from the fingerprint and signature the database in the memory unit 104 to check if the user is registered or not. After receiving a command signal from the command device 20, the microprocessor 102 will act as the command signal requests. For example, the microprocessor 102 will allow user to use additional data stored in the memory unit 104 according to the command signal. Finally, the microprocessor 102 requests the communication unit 103 to transmit the response signal back to the command device 20 to let the command device 20 know what has been done according to the command signal. The response signal includes a message that indicates whether the fingerprint images of the finger and the derived signature match a corresponding record in the fingerprint and the signature database or not. The response signal is also a response of the command signal.

According to the spirit of the present invention, the fingerprint images of the finger must be captured at a minimum speed above 15 frames per second. That is to say that the portable fingerprint device 10 can continuously capture multiple fingerprint images and those images have time correlation. In order to describe the advantage of this function, please refer to FIG. 5. When the image sensing unit 101 capture fingerprint image, subject to its size, only a portion of the fingerprint of a finger can be scanned. As shown in the upper part of FIG. 5, the first one of the fingerprint images is enclosed in the solid square. Since the portable fingerprint device 10 can continuously capture fingerprint images, when the finger moves over the image sensing unit 101, the image sensing unit 101 capture a second image enclosed in the long-dashed-lined square and a third image enclosed in the short-dashed-lined square. Therefore, three fingerprint images are recorded.

Not like conventional fingerprint readers which use only one fingerprint image for identification, the portable fingerprint device 10 according to the present invention can capture multiple fingerprint images at a speed of 15 frames per second or greater. The sequence of captured image can be analyzed to derive a signature pattern. Since both of the captured fingerprint images and the signature pattern are matched against the fingerprint and signature database, the security level is improved over using a single fingerprint image alone.

According to the present invention, it should be noticed that the command device 20 can be a notebook computer, a USB storage device, a mobile phone or a remote control unit. The communication unit 103 is not limited to a USB port for the USB connector; it can be a wireless transmitting module such as a 2.4 Ghz or Bluetooth device.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A portable fingerprint device, comprising:
a image sensing unit for capturing fingerprint images of a finger;
a microprocessor, linked to the image sensing unit, for recording the fingerprint images of the finger, identifying the fingerprint images of the finger from a fingerprint database, analyze the sequence of fingerprint images to determine the X/Y position of the finger in each image to derive a signature pattern, comparing the signature pattern with records stored in a signature database, receiving a command signal and transmitting a response signal; and
a communication unit, connected to the microprocessor, for transmitting the command signal and the response signal between the microprocessor and a command device separated from the portable fingerprint device.

2. The portable fingerprint device according to claim 1, further comprising:
a memory unit, linked to or embedded within the microprocessor, for storing the fingerprint and the signature databases.

3. The portable fingerprint device according to claim 1, wherein the command device comprises a software.

4. The portable fingerprint device according to claim 3, wherein the microprocessor receives a command signal sent by the software.

5. The portable fingerprint device according to claim 4, wherein the software requires the microprocessor to transmit the result of the fingerprint identification and signature verification of the recorded fingerprint images against the stored fingerprint and the signature database.

6. The portable fingerprint device according to claim 1, wherein the fingerprint images of the finger are captured at a frequency of 15 frames per second or higher.

7. The portable fingerprint device according to claim 1, wherein the command device is a notebook computer, a USB storage device, a mobile phone or a remote control unit.

8. The portable fingerprint device according to claim 1, wherein the communication unit is a USB port or a wireless transmitting module such as a 2.4 Ghz or Bluetooth device.

9. The portable fingerprint device according to claim 1, wherein the response signal is a response of the command signal.

10. The portable fingerprint device according to claim 1, wherein the response signal comprises a message that indicates whether the fingerprint images of the finger match a corresponding record in the fingerprint database or not.

11. The portable fingerprint device according to claim 1, wherein the response signal comprises a message that indicates whether the derived signature pattern from the fingerprint images match a corresponding record in the signature database or not.
